(19) United States
(12) Patent Application Publication
(10) Pub. No.: US 2010/0128112 A1
(43) Pub. Date: May 27, 2010

(54) IMMERSIVE DISPLAY SYSTEM FOR INTERACTING WITH THREE-DIMENSIONAL CONTENT

(75) Inventors: Stefan Marti, San Francisco, CA (US); Francisco Imai, Mountain View, CA (US); Seung Wook Kim, Santa Clara, CA (US)

Correspondence Address: Beyer Law Group LLP, P.O. BOX 1687, Cupertino, CA, 95015-1687, US

(73) Assignee: Samsung Electronics Co., Ltd, Suwon City (KR)

(21) Appl. No.: 12/323,789

(22) Filed: Nov. 26, 2008

(51) Int. Cl. H04N 13/00; G06K 9/00

(52) U.S. Cl. 348/51; 382/103; 348/E13.001; 382/154

(57) ABSTRACT

A system for displaying three-dimensional (3-D) content and enabling a user to interact with the content in an immersive, realistic environment is described. The system has a display component that is non-planar and provides the user with an extended field-of-view (FOV), one factor in the creating the immersive user environment. The system also has a tracking sensor component for tracking a user face. The tracking sensor may include one or more 3-D and 2-D cameras. In addition to tracking the face or head, it may also track other body parts, such as hands and arms. An image perspective adjustment module processes data from the face tracking and enables the user to perceive the 3-D content with motion parallax. The hand and other body part output data is used by gesture detection modules to detect collisions between the user's hand and 3-D content. When a collision is detected, there may be tactile feedback to the user to indicate that there has been contact with a 3-D object. All these components contribute towards creating an immersive and realistic environment for viewing and interacting with 3-D content.

### BACKGROUND OF THE INVENTION

1. Field of the Invention

The present invention relates generally to systems and user interfaces for interacting with three-dimensional content. More specifically, the invention relates to systems for human-computer interaction relating to three-dimensional content.

2. Description of the Related Art

The amount of three-dimensional content available on the Internet and in other contexts, such as in video games and medical imaging, is increasing at a rapid pace. Consumers are getting more accustomed to hearing about “3-D” in various contexts, such as movies, games, and online virtual cities. Current systems, which may include computers, but more generally, content display systems (e.g., TVs) fall short of taking advantage of 3-D content by not providing an immersive user experience. For example, they do not provide an intuitive, natural and unintrusive interaction with 3-D objects. Three-dimensional content may be found in medical imaging (e.g., examining MRIs), online virtual worlds (e.g., Second City), modeling and prototyping, video gaming, information visualization, architecture, tele-immersion and collaboration, geographic information systems (e.g., Google Earth), and in other fields.

The advantages and experience of dealing with 3-D content are not fully realized on current two-dimensional display systems. Current display systems that are able to provide interaction with 3-D content require inconvenient or intrusive peripherals that make the experience unnatural to the user. For example, some current methods of providing tactile feedback require vibro-tactile gloves. In other examples, current methods of rendering 3-D content include stereoscopic displays (requiring the user to wear a pair of special glasses), auto-stereoscopic displays (based on lenticular lenses or parallax barriers that cause eye strain and headaches as usual side effects), head-mounted displays (requiring heavy head gear or goggles), and volumetric displays, such as those based on oscillating mirrors or screens (which do not allow bare hand direct manipulation of 3-D content).

Some present display systems use a single planar screen which has a limited field of view. Other systems do not provide bare hand interaction to manipulate virtual objects intuitively. As a result, current systems do not provide a closed-interaction loop in the user experience because there is no haptic feedback, thereby preventing the user from sensing the 3-D objects in, for example, an online virtual world. Present systems may also use only conventional or two-dimensional cameras for hand and face tracking.

### SUMMARY OF THE INVENTION

In one embodiment, a system for displaying and interacting with three-dimensional (3-D) content is described. The system, which may be a computing or non-computing system, has a non-planar display component. This component may include a combination of one or more planar displays arranged in a manner to emulate a non-planar display. It may also include one or more curved displays alone or in combination with non-planar displays. The non-planar display component provides a field-of-view (FOV) to the user that enhances the user's interaction with the 3-D content and provides an immersive environment. The FOV provided by the non-planar display component is greater than the FOV provided by conventional display components. The system may also include a tracking sensor component for tracking a user face and outputting face tracking output data. An image perspective adjustment module processes the face tracking output data and thereby enables a user to perceive the 3-D content with motion parallax.

In other embodiments, the tracking sensor component may have at least one 3-D camera or may have at least two 2-D cameras, or a combination of both. In other embodiments, the image perspective adjustment module enables adjustment of 3-D content images displayed on the non-planar display component such that image adjustment depends on a user head position. In another embodiment, the system includes a tactile feedback controller in communication with at least one vibro-tactile actuator. The actuator may provide tactile feedback to the user when a collision between the user hand and the 3-D content is detected.

Another embodiment of the present invention is a method of providing an immersive user environment for interacting with 3-D content. Three-dimensional content is displayed on a non-planar display component. User head position is tracked and head tracking output data is created. The user perspective of 3-D content is adjusted according to the user head tracking output data, such that the user perspective of 3-D content changes in a natural manner as a user head moves when viewing the 3-D content on the non-planar display component.

In other embodiments, a collision is detected between a user body part and the 3-D content, resulting in tactile feedback to the user. In another embodiment, when the 3-D content is displayed on a non-planar display component, an extended horizontal and vertical FOV is provided to the user when viewing the 3-D content on the display component.

### BRIEF DESCRIPTION OF THE DRAWINGS

References are made to the accompanying drawings, which form a part of the description and in which are shown, by way of illustration, particular embodiments:

FIGS. 1A to 1E are example configurations of display components for displaying 3-D content in accordance with various embodiments;

FIG. 2 is a diagram showing one example of placement of a tracking sensor component in an example display configuration in accordance with one embodiment;

FIG. 3 is a flow diagram describing a process of view-dependent rendering in accordance with one embodiment;

FIG. 4 is a logical block diagram showing various software modules and hardware components of a system for providing an immersive user experience when interacting with digital 3-D content in accordance with one embodiment;

FIG. 5 is a flow diagram of a process of providing haptic feedback to a user and adjusting user perspective of 3-D content in accordance with one embodiment;

FIG. 6A is an illustration of a system providing an immersive environment for interacting with 3-D content in accordance with one embodiment;

FIG. 6B is an illustration of a system providing an immersive environment 612 for interacting with 3-D content in accordance with another embodiment; and

FIGS. 7A and 7B illustrate a computer system suitable for implementing embodiments of the present invention.

### DETAILED DESCRIPTION OF THE INVENTION

Methods and systems for creating an immersive and natural user experience when viewing and interacting with three-dimensional (3-D) content using an immersive system are described in the figures. Three-dimensional interactive systems described in the various embodiments describe providing an immersive, realistic and encompassing experience when interacting with 3-D content, for example, by having a non-planar display component that provides an extended field-of-view (FOV) which, in one embodiment, is the maximum number of degrees of visual angle that can be seen on a display component. Examples of non-planar displays include curved displays and multiple planar displays configured at various angles, as described below. Other embodiments of the system may include bare-hand manipulation of 3-D objects, making interactions with 3-D content not only more visually realistic to users, but more natural and life-like. In another embodiment, this manipulation of 3-D objects or content may be augmented with haptic (tactile) feedback, providing the user with some type of physical sensation when interacting with the content. In another embodiment, the immersive display and interactive environment described in the figures may also be used to display 2.5-D content. This category of content may include, for example, an image with depth information per pixel, where the system does not have a complete 3-D model of the scene or image being displayed.

In one embodiment, a user perceives 3-D content in a display component in which her perspective of 3-D objects changes as her head moves. As noted, in another embodiment, she is able to “feel” the object with her bare hands. The system enables immediate reaction to the user's head movement (changing perspective) and hand gestures. The illusion that the user can hold a 3-D object and manipulate it is maintained in an immersive environment. One aspect of maintaining this illusion is motion parallax, a feature of view dependent rendering (VDR).

In one embodiment, a user's visual experience is determined by a non-planar display component made up of multiple planar or flat display monitors. The display component has a FOV that creates an immersive 3-D environment and, generally, may be characterized as being an extended FOV, that is, a FOV that exceeds or extends the FOV of conventional planar display (i.e., ones that are not unusually wide) viewed at a normal distance. In the various embodiments, this extended FOV may extend from 60 degrees to upper limits as high as 360 degrees, where the user is surrounded. For purposes of comparison, a typical horizontal FOV (left-right) for a user viewing normal 2-D content on a single planar 20″ monitor from a distance of approximately 18″ is about 48 degrees. There are numerous variables that may increase this value, for example, if the user views the display from a very close distance (e.g., 4″ away) or if the display is unusually wide (e.g., 50″ or greater), these factors may increase the horizontal FOV, but generally not filling the complete human visual field. Field-of-view may be extended both horizontally (extending a user's peripheral vision) and vertically, the number of degrees the user can see objects looking up and down. The various embodiments of the present invention increase or extend the FOV under normal viewing circumstances, that is, under conditions that an average home or office user would view 3-D content, which, as a practical matter, is not very different from how they view 2-D content, i.e., the distance from the monitor is about the same. However, how they interact with 3-D content is quite different. For example, there may be more head movement and arm/hand gestures when users try to reach out and manipulate or touch 3-D objects.

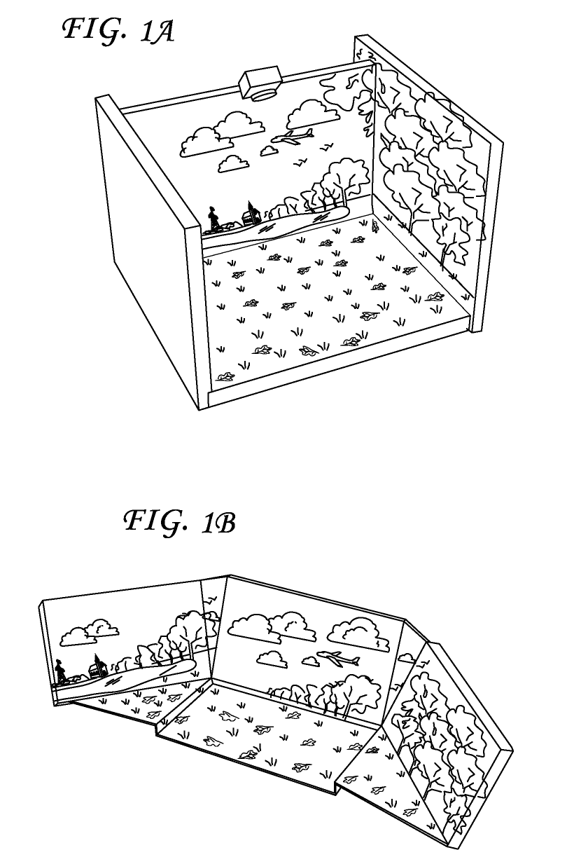

FIGS. 1A to 1E are diagrams showing different example configurations comprised of multiple planar displays and one configuration having a non-planar display in accordance with various embodiments. The configurations in FIGS. 1A to 1D extend a user's horizontal FOV. FIG. 1E is an example display component configuration that extends only the vertical FOV. Generally, an array of planar (flat) displays may be tiled or configured to resemble a “curved” space. In some embodiments, non-planar displays, including flexible or bendable displays, may be used to create an actual curved space. These include projection displays, which may also be used to create non-square or non-rectangular (e.g., triangular shaped) displays monitors (or monitor segments). There may also be a combination of flat and curved displays elements. These various embodiments enable display components in the shape of trapezoids, tetrahedrons, pyramids, domes or hemispheres, among other shapes. Such displays may be actively self-emitting displays (LCD, organic LCD, etc) or, as noted, projection displays. Also, with projection displays, a display component may also have a foldable or collapsible configuration.

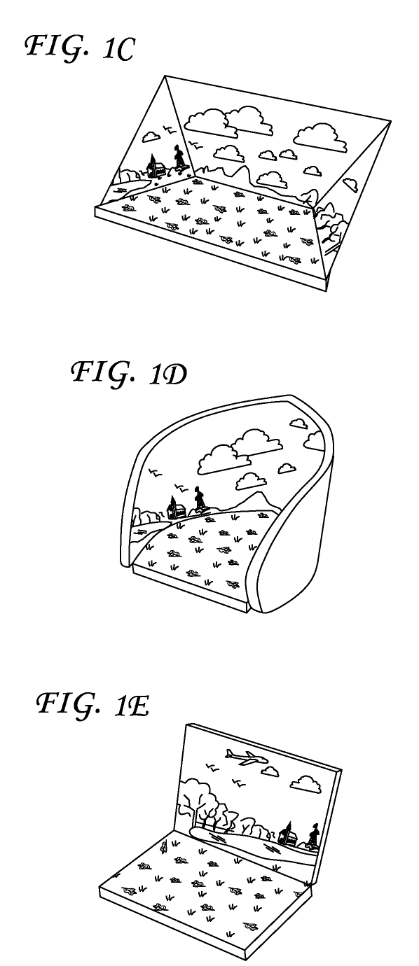

FIG. 1A is a sample configuration of a display component having four planar displays (three vertical, one horizontal) to create a box-shaped (cuboid) display area. It is worth noting here that this and the other display configurations describe a display component which is one component in the overall immersive volumetric system enabling a user to interact and view 3-D content. The FOV depends on the position of the user's head. If the user “leans into the box” of the display configuration of FIG. 1A, and the center of the user's eyes is roughly in the “middle” of the box (center of the cuboid), this may result in a horizontal FOV of 250 degrees, and vertically 180 degrees. If the user does not lean into the box, and aligns her eyes with the front edge of the horizontal display and looks at the center of the back vertical display, this may result in a horizontal FOV of 180 degrees, and vertically approximately 110 degrees. In general, the further away a user sits from the display, the more both FOV angles get reduced. This concept applies for FOVs of all configurations. FIG. 1E is another sample configuration that may be described as a “subset” of the configuration in FIG. 1A, in that the vertical FOV is the same (with one generally vertical, frontal display and a bottom horizontal display). The vertical display provides the conventional 48 degrees (approx.) FOV, while the bottom horizontal display extends the vertical FOV to 180 degrees. FIG. 1A has two side vertical displays that increase the horizontal FOV to 180 degrees. Also shown in FIG. 1A is a tracking sensor, various embodiments and arrangements of which are described in FIG. 2.

FIG. 1B shows another example configuration of a display component having four, rectangular planar displays, three that are generally vertical, leaning slightly away from the user (which may be adjusted), and one that is horizontal, increasing the vertical FOV (similar to FIGS. 1A and 1E). Also included are four triangular, planar displays used to essentially tile or connect the rectangular displays to create a contiguous, immersive display area or space. As noted above, the horizontal and vertical FOVs depend on where the user's head is, but generally is greater than the conventional configuration of a single planar display viewed from a typical distance. In this configuration the user is provided with a more expansive (“roomier”) display area compared to the box-shaped display of FIG. 1A. FIG. 1C shows another example configuration that is similar to FIG. 1A but has side, triangular-shaped displays that are angled away from the user (again, this may be adjustable). The vertical front display may be angled away from the user or be directly upright. In this configuration the vertical FOV is 140 degrees and the horizontal FOV is approximately 180 degrees.

FIG. 1D shows another example configuration of a display component with a non-planar display that extends the user's horizontal FOV beyond 180 degrees to approximately 200 degrees. In this embodiment, rather than using multiple planar displays a flexible, an actual curved display is used to create the immersive environment. The horizontal surface in FIG. 1D may also be a display, which would increase the vertical FOV to 180 degrees. Curved, portable displays may be implemented using projection technology (e.g., nano-projection systems) or emerging flexible displays. As noted, projection may also enable non-square shaped displays and foldable displays. In another embodiment, multiple planar displays may be combined or connected at angles to create the illusion of a curved space. In this embodiment, generally the more planar displays that are used, the angle needed to connect the displays is smaller and the illusion or appearance of having a curved display is greater. Likewise, fewer planar displays may require larger angles. These are only example configurations of display components; there may be many others that extend the horizontal and vertical FOVs. For example, by using a foldable display configuration, a display component may have a horizontal display overhead. Generally, one feature used in the present invention to create a more immersive user environment for interacting and viewing 3-D content is increasing the horizontal and/or vertical FOVs using a non-planar display component.

FIG. 2 shows one example of placement of a tracking sensor component (or tracking component) in the display configuration of FIG. 1E in accordance with one embodiment. Tracking sensors, for example, 3-D and 2-D (conventional) cameras, may be placed at various locations in a display configuration. These sensors, described in greater detail below, are used to track a user's head (typically by tracking facial features) and to track user body part movements and gestures, typically of a user's arms, hands, wrists, fingers, and torso. In FIG. 2, a 3-D camera, represented by a square box 202, is placed at the center of a vertical display 204. In another embodiment, two 2-D cameras, represented by circles 206 and 208, are placed at the top corners of vertical display 204. In other embodiments, both types of cameras are used. In FIG. 1A, a single 3-D camera is shown at the top center of the front, vertical display. In other configurations, cameras may also be positioned on the left-most and right-most corners of the display component, essentially facing sideways at the user. Other types of tracking sensors include thermal cameras or cameras with spectral processing. In another embodiment, a wide angle lens may be used in a camera which may require less processing by an imaging system, but may produce more distortion. Sensors and cameras are described further below. FIG. 2 is intended to describe the various configurations of tracking sensors. A given configuration of one or more tracking sensors is referred to as a tracking component. The one or more tracking sensors in the given tracking component may be comprised of various types of cameras and/or non-camera type sensors. In FIG. 2, cameras 206 and 208 collectively comprise a tracking component or camera 202 alone may be a tracking component, or a combination of camera 202, place in between cameras 206 and 208, for example, may comprise another tracking component.

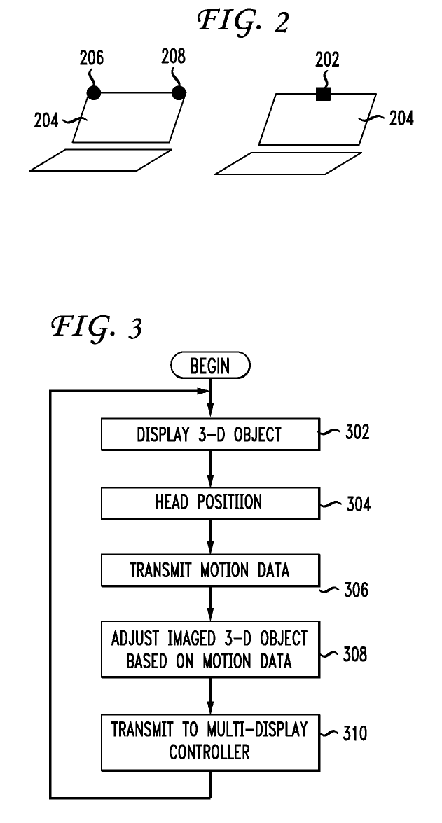

In one embodiment, a tracking component provides user head tracking which may be used to adjust user image perspective. As noted, a user viewing 3-D content is likely to move her head to the left or right. To maintain the immersive 3-D experience, the image being viewed is adjusted if the user moves to the left, right, up or down to reflect the new perspective. For example, when viewing a 3-D image of a person, if the user (facing the 3-D person) moves to the left, she will see the right side of the person and if to the user moves to the right, she will see the left side of the person. The image is adjusted to reflect the new perspective. This is referred to as view-dependent rendering (VDR) and the specific feature, as noted earlier, is motion parallax. VDR requires that the user's head be tracked so that the appearance of the 3-D object in the display component being viewed changes while the user's head moves. That is, if the user looks straight at an object and then moves her head to the right, she will expect that her view of the object changes from a frontal view to a side view. If she still sees a frontal view of the object, the illusion of viewing a 3-D object breaks down immediately. VDR adjusts the user's perspective of the image using a tracking component and face tracking software. These processes are described in FIG. 3.

FIG. 3 is a flow diagram describing a process of VDR in accordance with one embodiment. It describes how movement of a user's head effects the perspective and rendering of 3-D content images in a display component, such as one described in FIGS. 1A to 1E (there are many other examples) having extended FOVs. It should be noted that steps of the methods shown and described need not be performed (and in some implementations are not performed) in the order indicated, may be performed concurrently, or may include more or fewer steps than those described. The order shown here illustrates one embodiment. It is also noted that the immersive volumetric system of the present invention may be a computing system or a non-computing type system, and, as such, may include, a computer (PC, laptop, server, tablet, etc.), TV, home theater, hand-held video gaming device, mobile computing devices, or other portable devices. As noted above, a display component may be comprised of multiple planar and/or non-planar displays, example embodiments of which are shown in FIGS. 1A to 1E.

The process begins at step 302 with a user viewing the 3-D content, looking straight at the content on a display directly in front of her (it is assumed that there will typically be a display screen directly in front of the user). When the user moves her head while looking at a 3-D object, a tracking component (comprised of one or more tracking sensors) detects that the user's head position has changed. It may do this by tracking the user's facial features. Tracking sensors detect the position of the user's head within a display area or, more specifically, within the detection range of the sensor or sensors. In one example, there is one 3-D camera and two 2-D cameras used to collectively comprise a tracking component of the system. In other embodiments, more or fewer sensors may be used or a combination of various sensors may be used, such as 3-D camera and spectral or thermal camera. The number and placement may depend on the configuration of a display component.

At step 304, head position data is sent to head tracking software. The format of this “raw” head position data from the sensors will depend on the type of sensors being used, but may be in the form of 3-D coordinate data (in the Cartesian coordinate system, e.g., three numbers indicating x, y, and z distance from the center of the display component) plus head orientation data (attitude, e.g., three numbers indicating the roll, pitch, and yaw angle in reference to the Earth's gravity vector). Once the head tracking software has processed the head position data, making it suitable for transmission to and use by other components in the system, the data is transmitted to an image perspective adjustment module at step 306.

At step 308 the image perspective adjustment module, also referred to as a VDR module, adjusts the graphics data representing the 3-D content so that when the content is rendered on the display component, the 3-D content is rendered in a manner that corresponds to the new perspective of the user after the user has moved her head. For example, if the user moved her head to the right, the graphics data representing the 3-D content is adjusted so that the left side of an object will be rendered on the display component. If the user moves her head slightly down and to the left, the content is adjusted so that the user will see the right side of an object from the perspective of slightly looking up at the object. At step 310 the adjusted graphics data representing the 3-D content is transmitted to a display component calibration software module. From there it is sent to a multi-display controller for display mapping, image warping and other functions that may be needed for rendering the 3-D content on the multiple planar or non-planar displays comprising the display component. The process may then effectively return to step 302 where the 3-D content is shown on the display component so that images are rendered dependent on the view or perspective of the user.

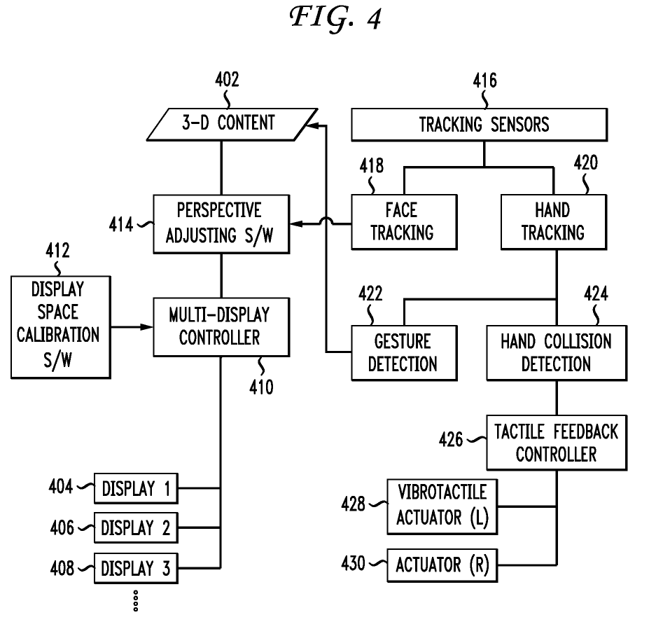

FIG. 4 is a logical block diagram showing various software modules and hardware components of a system for providing an immersive user experience when interacting with digital 3-D content in accordance with one embodiment. Also shown are some of the data transmissions among the modules and components relating to some embodiments. The graphics data representing digital 3-D content is represented by box 402. Digital 3-D data 402 is the data that is rendered on the display component. The displays or screens comprising the display component are shown as display 404, display 406, and display 408. As described above, there may be more or few displays comprising the display component. Displays 404-408 may be planar or non-planar, self-emitting or projection, and have other characteristics as described above (e.g., foldable). These displays are in communication with a multi-display controller 410 which receives input from display space calibration software 412. This software is tailored to the specific characteristics of the display component (i.e., number of displays, angles connecting the displays, display types, graphic capabilities, etc.).

Multi-display controller 410 is instructed by software 412 on how to take 3-D content 402 and display it on multiple displays 404-408. In one embodiment, display space calibration software 412 renders 3-D content with seamless perspective on multiple displays. One function of calibration software 412 may be to seamlessly display 3-D content images on, for example, non-planar displays while maintaining color and image consistency. In one embodiment, this may be done by electronic display calibration (calibrating and characterizing display devices). It may also perform image warping to reduce spatial distortion. In one embodiment, there are images for each graphics card which preserves continuity and smoothness in the image display. This allows for consistent overall appearance (color, brightness, and other factors). Multi-display controller 410 and 3-D content 402 are in communication with a perspective adjusting software component or VDR component 414 which performs critical operations on the 3-D content before it is displayed. Before discussing this component in detail, it is helpful to first describe the tracking component and the haptic augmentation component which enables tactile feedback in some embodiments.

As noted, tracking component 416 of the system tracks various body parts. One configuration may include one 3-D camera and two 2-D cameras. Another configuration may include only one 3-D camera or only two 2-D cameras. A 3-D camera may provide depth data which simplifies gesture recognition by use of depth keying. In one embodiment, tracking component 416 transmits body parts position data to both a face tracking module 418 and a hand tracking module 420. A user's face and hands are tracked at the same time by the sensors (both may be moving concurrently). Face tracking software module 418 detects features of a human face and the position of the face. Tracking sensor 416 inputs the data to software module 418. Similarly, hand tracking software module 420 detects user body parts positions, although they may focus on the position of the user's hand, fingers, and arm. Tracking sensors 416 are responsible for tracking the position of the body parts within their range of detection. This position data is transmitted to tracking software 418 and hand tracking software 420 and each identifies the features that are relevant to each module.

Head tracking software component 418 processes the position of the face or head and transmits this data (essentially data indicating where the user's head is) to perspective adjusting software module 414. Module 414 adjusts the 3-D content to correspond to the new perspective based on head location. Software 418 identifies features of a face and is able to determine the location of the user's head within the immersive user environment.

Hand tracking software module 420 identifies features of a user's hands and arms and determines the location of these body parts in the environment. Data from software 420 goes to two components related to hand and arm position: gesture detection software module 422 and hand collision detection module 424. In one embodiment, a user “gesture” results in a modification of 3-D content 402. A gesture may include lifting, holding, squeezing, pinching, or rotating a 3-D object. These actions should result in some type of modification of the object in the 3-D environment. A modification of an object may include a change in its location (lifting or turning) without there being an actual deformation or change in shape of the object. It is useful to note that this modification of content is not the direct result of the user changing her perspective of the object, thus, in one embodiment, gesture detection data does not have to be transmitted to perspective adjusting software 414. Instead, the data may be applied directly to the graphics data representing 3-D content 402. However, in one embodiment, 3-D content 402 goes through software 414 at a subsequent stage given that the user's perspective of the 3-D object may (indirectly) change as result of the modification.

Hand collision detection module 424 detects a collision or contact between a user's hand and a 3-D object. In one embodiment, detection module 424 is closely related to gesture detection module 422 given that in a hand gesture involving a 3-D object, there is necessarily contact or collision between the hand and the object (hand gesturing in the air, such as waving, does not effect the 3-D content). When hand collision detection module 424 detects that there is contact between a hand (or other body part) and an object, it transmits data to a feedback controller. In the described embodiment, the controller is a tactile feedback controller 426, also referred to as a haptic feedback controller. In other embodiments, the system does not provide haptic augmentation and, therefore, does not have a feedback controller 426. This module receives data or a signal from detection module 424 indicating that there is contact between either the left, right, or both hands of the user and a 3-D object.

In one embodiment, depending on the data, controller 426 sends signals to one or two vibro-tactile actuators, 428 and 430. A vibro-tactile actuator may be a vibrating wristband or similar wrist gear that is unintrusive and does not detract from the natural, realistic experience of the system. When there is contact with a 3-D object, the actuator may vibrate or cause another type of physical sensation to the user indicating contact with a 3-D object. The strength and sensation may depend on the nature of the contact, the object, whether one or two hands were used, and so on, limited by the actual capabilities of the vibro-actuator mechanism. It is useful to note that when gesture detection module 422 detects that there is a hand gesture (at the initial indication of a gesture), hand collision detection module 424 concurrently sends a signal to tactile feedback controller 426. For example, if a user picks up a 3-D cup, as soon as the hand touches the cup and she picks it up immediately, gesture detection module 422 sends data to 3-D content 402 and collision detection module 424 sends a signal to controller 426. In other embodiments, there may only be one actuator mechanism (e.g., on only one hand). Generally, it is preferred that the mechanism be as unintrusive as possible, thus vibrating wristbands may be preferable over gloves, but gloves and other devices may be used for the tactile feedback. The vibro-tactile actuators may be wireless or wired.

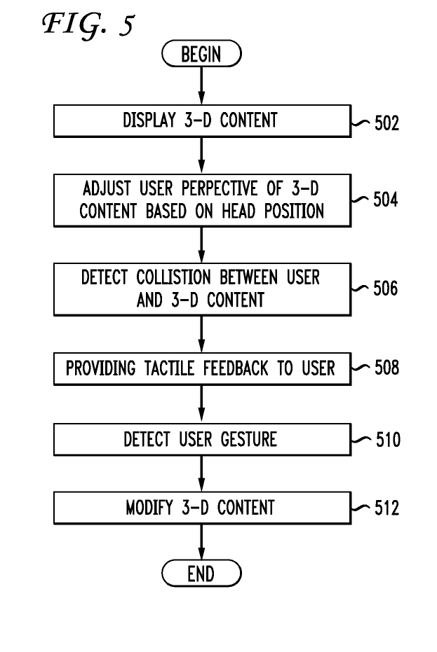

FIG. 5 is a flow diagram of a process of providing haptic feedback to a user and adjusting user perspective of 3-D content in accordance with one embodiment. Steps of the methods shown and described need not be performed (and in some implementations are not performed) in the order indicated, may be performed concurrently, or may include more or fewer steps than those described. At step 502 3-D content is displayed in a display component. The user views the 3-D content, for example, a virtual world, on the display component. At step 504 the user moves her head (the position of the user's head changes) within the detection range of the tracking component, thereby adjusting or changing her perspective of the 3-D content. As described above, this is done using face tracking and perspective adjusting software. The user may move a hand by reaching for a 3-D object. At step 506 the system detects a collision between the user hand and the object. In one embodiment, an “input-output coincidence” model is used to close a human-computer interaction feature referred to as a perception-action loop, where perception is what the user sees and action is what the user does. This enables a user to see the consequences of an interaction, such as touching a 3-D object, immediately. A user hand is aligned with or in the same position as the 3-D object that is being manipulated. That is, from the user's perspective, the hand is aligned with the 3-D object so that it looks like the user is lifting or moving a 3-D object as if it were a physical object. What the user sees makes sense based on the action being taken by the user.

In one embodiment, at step 508, the system provides tactile feedback to the user upon detecting a collision between the user's hand and the 3-D object. As described above, tactile feedback controller 426 receives a signal that there is a collision or contact and causes a tactile actuator to provide a physical sensation to the user. For example, with vibrating wristbands, the user's wrist will sense a vibration or similar physical sensation indicating contact with the 3-D object.

At step 510 the system detects that the user is making a gesture. In one embodiment, this detection is done concurrently with the collision detection of step 506. Examples of a gesture include lifting, holding, turning, squeezing, and pinching of an object. More generally, a gesture may be any type of user manipulation of a 3-D object that in some manner modifies the object by deforming it, changing its position, or both. At step 512 the system modifies the 3-D content based on the user gesture. The rendering of the 3-D object on the display component is changed accordingly and this may be done by the perspective adjusting module. As described in FIG. 4, in a different scenario as the one described in FIG. 5, the user may keep her head stationary and move a 3-D cup on a table from the center of the table (where she sees the center of the cup) to the left. The user's perspective on the cup has changed; she now sees the right side of the cup. This perspective adjustment may be done at step 512 using the same software used in step 504, except for the face tracking. The process then returns to step 502 where the modified 3-D content is displayed.

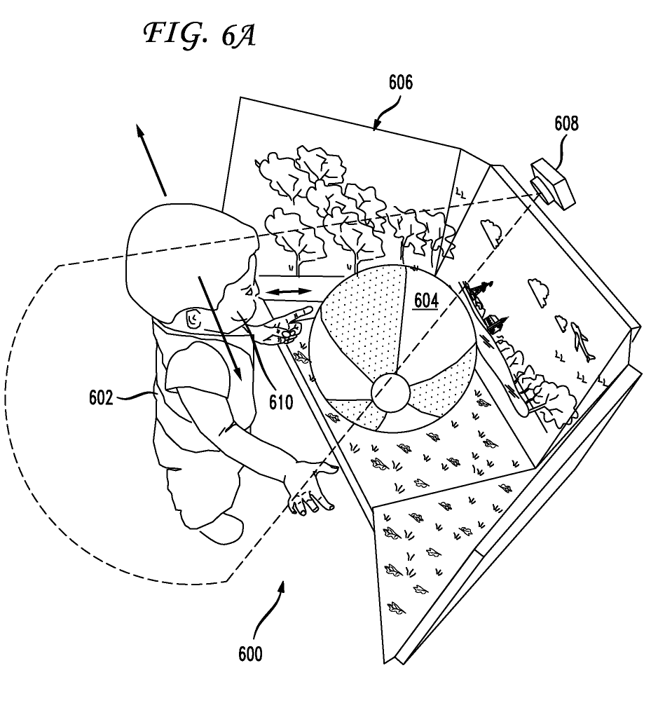

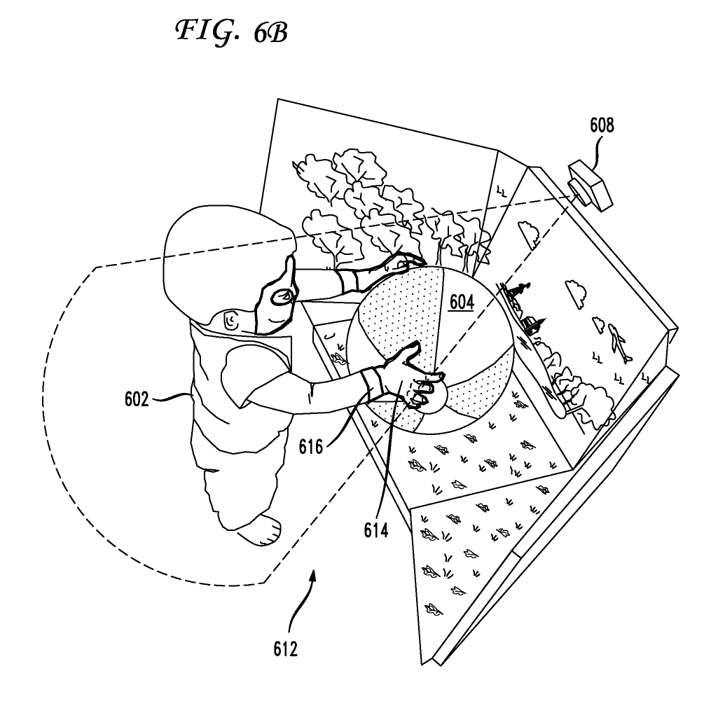

FIG. 6A is an illustration of a system providing an immersive environment 600 for interacting with 3-D content in accordance with one embodiment. In another embodiment, the user may be interacting with 2.5-D content, where a complete 3-D model of the image is not available and each pixel in the image contains depth information. A user 602 is shown viewing a 3-D object (a ball) 604 displayed in a display component 606. A 3-D camera 608 tracks the user's face 610. As user 602 moves his face 610 from left to right (indicated by the arrows), his perspective of ball 604 changes and this new perspective is implemented by a new rendering of ball 604 on display component 606 (similar to display component in FIG. 1B). The display of other 3-D content on display component 606 is also adjusted as user 602 moves his face 610 (or head) around within the detection range of camera 608. As described above, there may be more 3-D cameras positioned in environment 600. They may not necessarily be attached to display component 606 but may be separate or stand-alone cameras. There may also be one or more 2-D cameras (not shown) positioned in environment 600 that could be used for face tracking. Display component 606 is non-planar and in the embodiment shown in FIG. 6A is made up of multiple planar displays. Display component 606 provides a horizontal FOV to user 602 that is greater than would be generally attainable from a large single planar display regardless of how closely the display is viewed.

FIG. 6B is an illustration of a system providing an immersive environment 612 for interacting with 3-D content in accordance with another embodiment. User 602 is shown viewing ball 604 as in FIG. 6A. However, in environment 612 the user is also holding ball 604 and is experiencing tactile feedback from touching it. Although FIG. 6B shows ball 604 being held, it may also be manipulated in other ways, such as being turned, squeezed, or moved. In the embodiment shown, camera 608 tracks hands 614 of user 602 within environment 612. More generally, other user body parts, such as wrists, fingers, arms, and torso, may be tracked to determine what user 602 is doing with the 3-D content. Ball 604 and other 3-D content are modified based on what gestures user 602 is making with respect to the content. This modification is rendered on display component 606. As with environment 600 in FIG. 6A, the system may utilize other 3-D and 2-D cameras. In another embodiment, also shown in FIG. 6B, user 602 may use vibro-tactile actuators 616 mounted on the user's wrists. As described above, actuators 616 provide tactile feedback to user 602.

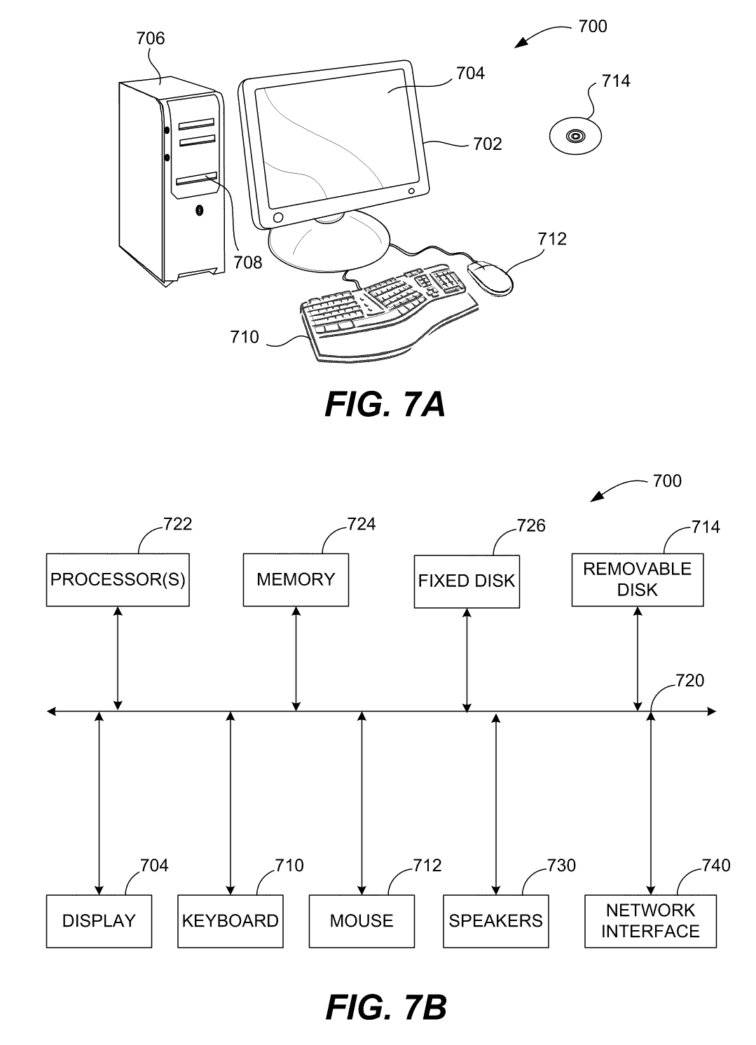

FIGS. 7A and 7B illustrate a computing system 700 suitable for implementing embodiments of the present invention. FIG. 7A shows one possible physical form of the computing system. Of course, the computing system may have many physical forms including an integrated circuit, a printed circuit board, a small handheld device (such as a mobile telephone, handset or PDA), a personal computer or a super computer. Computing system 700 includes a monitor 702, a display 704, a housing 706, a disk drive 708, a keyboard 710 and a mouse 712. Disk 714 is a computer-readable medium used to transfer data to and from computer system 700.

FIG. 7B is an example of a block diagram for computing system 700. Attached to system bus 720 are a wide variety of subsystems. Processor(s) 722 (also referred to as central processing units, or CPUs) are coupled to storage devices including memory 724. Memory 724 includes random access memory (RAM) and read-only memory (ROM). As is well known in the art, ROM acts to transfer data and instructions uni-directionally to the CPU and RAM is used typically to transfer data and instructions in a bi-directional manner. Both of these types of memories may include any suitable of the computer-readable media described below. A fixed disk 726 is also coupled bi-directionally to CPU 722; it provides additional data storage capacity and may also include any of the computer-readable media described below. Fixed disk 726 may be used to store programs, data and the like and is typically a secondary storage medium (such as a hard disk) that is slower than primary storage. It will be appreciated that the information retained within fixed disk 726, may, in appropriate cases, be incorporated in standard fashion as virtual memory in memory 724. Removable disk 714 may take the form of any of the computer-readable media described below.

CPU 722 is also coupled to a variety of input/output devices such as display 704, keyboard 710, mouse 712 and speakers 730. In general, an input/output device may be any of: video displays, track balls, mice, keyboards, microphones, touch-sensitive displays, transducer card readers, magnetic or paper tape readers, tablets, styluses, voice or handwriting recognizers, biometrics readers, or other computers. CPU 722 optionally may be coupled to another computer or telecommunications network using network interface 740. With such a network interface, it is contemplated that the CPU might receive information from the network, or might output information to the network in the course of performing the above-described method steps. Furthermore, method embodiments of the present invention may execute solely upon CPU 722 or may execute over a network such as the Internet in conjunction with a remote CPU that shares a portion of the processing.

Although illustrative embodiments and applications of this invention are shown and described herein, many variations and modifications are possible which remain within the concept, scope, and spirit of the invention, and these variations would become clear to those of ordinary skill in the art after perusal of this application. Accordingly, the embodiments described are illustrative and not restrictive, and the invention is not to be limited to the details given herein, but may be modified within the scope and equivalents of the appended claims.

What is claimed is:

1. A system for displaying three-dimensional (3-D) content, the system comprising:
a non-planar display component;
a tracking sensor component for tracking a user face and outputting face tracking output data; and
an image perspective adjustment module for processing face tracking output data, thereby enabling a user to perceive the 3-D content with motion parallax.

2. A system as recited in claim 1 wherein the tracking sensor component further comprises at least one 3-D camera.

3. A system as recited in claim 1 wherein the tracking sensor component further comprises at least one two-dimensional (2-D) camera.

4. A system as recited in claim 1 wherein the tracking sensor component further comprises at least one 3-D camera and at least one 2-D camera.

5. A system as recited in claim 1 wherein the non-planar display component further comprises two or more planar display monitors in a non-planar arrangement.

6. A system as recited in claim 5 wherein a planar display monitor is a self-emitting display monitor.

7. A system as recited in claim 1 wherein the non-planar display component further comprises one or more non-planar display monitors.

8. A system as recited in claim 7 wherein the non-planar display monitor is a projection display monitor.

9. A system as recited in claim 1 further comprising:
a display space calibration module for coordinating two or more images displayed on the non-planar display component.

10. A system as recited in claim 9 wherein the display space calibration module processes non-planar display angle data relating to two or more non-planar display monitors.

11. A system as recited in claim 1 wherein the non-planar display component provides a curved display space.

12. A system as recited in claim 1 wherein the image perspective adjustment module enables adjustment of 3-D content images displayed on the non-planar display component, wherein said image adjustment depends on a user head position.

13. A system as recited in claim 1 further comprising:
a tactile feedback controller in communication with at least one vibro-tactile actuator, the actuator providing tactile feedback to the user when a collision between the user hand and the 3-D content is detected.

14. A system as recited in claim 13 wherein the at least one vibro-tactile actuator is a wrist bracelet.

15. A system as recited in claim 1 further comprising a multi-display controller.

16. A system as recited in claim 1 wherein the tracking sensor component tracks a user body part and outputs body part tracking output data.

17. A system as recited in claim 16 further comprising a gesture detection module for processing the body part tracking output data.

18. A system as recited in claim 17 further comprising a body part collision module for processing the body part tracking output data.

19. A system as recited in claim 16 wherein the body part tracking output data includes user body part location data with reference to displayed 3-D content and is transmitted to the tactile feedback controller.

20. A system as recited in claim 16 wherein the tracking sensor component determines a position and an orientation of the user body part in a 3-D space by detecting a plurality of features of the user body part.

21. A method of providing an immersive user environment for interacting with 3-D content, the method comprising:
displaying the 3-D content on a non-planar display component;
tracking user head position, thereby creating head tracking output data; and
adjusting a user perspective of 3-D content according to the user head tracking output data, such that the user perspective of 3-D content changes in a natural manner as a user head moves when viewing the 3-D content on the non-planar display component.

22. A method as recited in claim 21 further comprising:
detecting a collision between a user body part and the 3-D content.

23. A method as recited in claim 21 wherein detecting a collision further comprises providing tactile feedback.

24. A method as recited in claim 22 further comprising:
determining a location of the user body part with reference to 3-D content location.

25. A method as recited in claim 21 further comprising:
detecting a user gesture with reference to the 3-D content, wherein the 3-D content is modified based on the user gesture.

26. A method as recited in claim 25 wherein modifying 3-D content further comprises deforming the 3-D content.

27. A method as recited in claim 21 further comprising:
tracking a user body part to determine a position of the body part.

28. A method as recited in claim 21 further comprising receiving 3-D content coordinates.

29. A method as recited in claim 22 further comprising enabling manipulation of the 3-D content when a user body part is visually aligned with the 3-D content from the user perspective.

30. A method as recited in claim 21 wherein displaying the 3-D content on a non-planar display component further comprises:
providing an extended horizontal field-of-view to a user when viewing the 3-D content on the non-planar display component.

31. A method as recited in claim 21 wherein displaying the 3-D content on a non-planar display component further comprises:
providing an extended vertical field-of-view to a user when viewing the 3-D content on the non-planar display component.

32. A system for providing an immersive user environment for interacting with 3-D content, the system comprising:
means for displaying the 3-D content;
means for tracking user head position, thereby creating head tracking output data; and
means for adjusting a user perspective of 3-D content according to the user head tracking output data, such that the user perspective of 3-D content changes in a natural manner as a user head moves when viewing the 3-D content.

33. A system as recited in claim 32 further comprising:
means for detecting a collision between a user body part and the 3-D content.

34. A system as recited in claim 33 wherein the means for detecting a collision further comprises means for providing tactile feedback.

35. A system as recited in claim 33 further comprising:
means for determining a location of the user body part with reference to 3-D content location.

36. A system as recited in claim 32 further comprising:
means for detecting a user gesture with reference to the 3-D content, wherein the 3-D content is modified based on the user gesture.

37. A computer-readable medium storing computer instructions for providing an immersive user environment for interacting with 3-D content in a 3-D viewing system, the computer-readable medium comprising:
computer code for displaying the 3-D content on a non-planar display component;
computer code for tracking user head position, thereby creating head tracking output data; and
computer code for adjusting a user perspective of 3-D content according to the user head tracking output data, such that the user perspective of 3-D content changes in a natural manner as a user head moves when viewing the 3-D content on the non-planar display component.

38. A computer-readable medium as recited in claim 37 further comprising:
computer code for detecting a collision between a user body part and the 3-D content.

39. A computer-readable medium as recited in claim 38 wherein computer code for detecting a collision further comprises computer code for providing tactile feedback.

40. A computer-readable medium as recited in claim 37 further comprising:
computer code for determining a location of the user body part with reference to 3-D content location.

41. A computer-readable medium method as recited in claim 37 further comprising:
computer code for detecting a user gesture with reference to the 3-D content, wherein the 3-D content is modified based on the user gesture.
